(19) United States
(12) Patent Application Publication
(10) Pub. No.: US 2004/0236653 A1
(43) Pub. Date: Nov. 25, 2004

(54) System and method for associating identifiers with data

(76) Inventors: Jeremy N. Sokolic, New York, NY (US); Balraj Suneja, Norwalk, CT (US); Amitava Parial, Newark, CA (US); Sarabjeet Singh, San Jose, CA (US); Gautam Sinha, Fremont, CA (US); Sanjeev Dheer, Scarsdale, NY (US)

Correspondence Address: LEE & HAYES, PLLC, 421 W. RIVERSIDE AVE, STE 500, SPOKANE, WA, 99201, US

(21) Appl. No.: 10/769,036

(22) Filed: Jan. 30, 2004

Related U.S. Application Data
(63) Continuation-in-part of application No. 10/040,314, filed on Jan. 3, 2002.

(51) Int. Cl. G06F 17/60

(52) U.S. Cl. 705/35

(57) ABSTRACT

Financial data having multiple financial data elements is retrieved from a data source. A procedure identifies multiple rules associated with the financial data elements. Those multiple rules are applied to the financial data elements such that each of the financial data elements is associated with an identifier. The procedure then identifies additional information regarding a particular financial data element using the identifier associated with the financial data element.

### RELATED APPLICATIONS

This application is a continuation-in-part of co-pending application Ser. No. 10/040,314, filed Jan. 3, 2002, entitled “Method and Apparatus for Retrieving and Processing Data”, and incorporated herein by reference.

### TECHNICAL FIELD

The present invention relates to associating identifiers with data, such as financial data.

### BACKGROUND

Individuals, businesses, and other organizations typically maintain one or more financial accounts at one or more financial institutions. Financial institutions include, for example, investment institutions, life insurance vendors, banks, savings and loans, credit unions, mortgage companies, lending companies, and stock brokers. Financial accounts may include asset accounts (such as brokerage accounts, investment accounts, 401k accounts, other retirement accounts, mutual fund accounts, life insurance and annuity accounts, bank savings accounts, checking accounts, and certificates of deposit (CDs)) and liability accounts (such as credit card accounts, mortgage accounts, home equity loans, overdraft protection, and other types of loans). Liability accounts may also be referred to as “debt accounts”.

Many financial institutions allow customers to access information regarding their accounts via the Internet or other remote connection mechanism (often referred to as “online banking”). Typically, the customer navigates, using a web browser application, to a web site maintained by the financial institution. The web site allows the customer to login by entering a user identification and an associated password. If the financial institution accepts the user identification and password, the customer is permitted to access information (e.g., account holdings and account balances) regarding the financial accounts maintained at that financial institution.

Similarly, other organizations and institutions allow customer access to other types of accounts, such as email accounts, award (or reward) accounts, online bill payment accounts, etc. A user may navigate a web site or other information source to receive status information regarding one or more of their accounts.

Account information (such as information regarding publicly traded financial securities held as investment positions and account transactions) associated with different financial institutions may have different identifiers associated with the account information. Data collected regarding investment securities, such as data gathered from different web-based online financial accounts, often lacks a standard unique identifier. For example, some data sources provide a ticker symbol, but the ticker symbol is neither unique nor consistent from one data source to another. For some securities there are no ticker symbols. For example, one data source (e.g., a brokerage firm) may list a security's ticker as “ACME.A” while another data source uses a different ticker (“ACME_A”) for the same security. Other data sources may use “ACME'A” or “ACME A” for this same security. Further, the name assigned to the security may vary from one data source to another. For example, for the above security, different data sources may name the security “ACME SYSTEMS INC CL A”, “Acme Systems A”, or “ACME SYSTEMS class A”—all identifying the same class A common stock associated with Acme Systems Inc.

In other situations, a data source may not provide any ticker symbol or other identifier for a particular security. As mentioned above, the name assigned to the same security may vary from one data source to another. These inconsistencies lead to difficulties in properly identifying and handling information regarding securities when the information is collected from multiple sources.

### BRIEF DESCRIPTION OF THE DRAWINGS

FIG. 1 illustrates an example network environment in which various servers, computing devices, and a financial analysis system exchange data across a network, such as the Internet.

FIG. 2 is a block diagram showing example components and modules of a financial analysis system.

FIGS. 3A and 3B illustrate a flow diagram of a procedure for retrieving data and associating identifiers with the retrieved data.

FIG. 4 is a flow diagram illustrating a procedure for retrieving data and associating asset identifiers with the retrieved data based on various rules.

FIG. 5 is a flow diagram illustrating a procedure 500 for applying various rules or search patterns to determine an identifier associated with a data element.

FIG. 6 illustrates an example set of rules used to associate data elements with identifiers.

FIG. 7 is a block diagram showing pertinent components of a computer in accordance with the invention.

### DETAILED DESCRIPTION

The systems and methods described herein are capable of retrieving and handling data from one or more data sources, such as financial institutions. In particular, these systems and methods are capable of assigning a common set of identifiers to aggregated data using rules that contain, for example, information regarding financial securities, financial institutions, financial institution web sites and other processing procedures.

A particular data source may contain financial account information, such as financial securities, associated with one or more customers of the corresponding financial institution. Each data element retrieved is associated with a particular identifier, such as an asset identifier or a transaction identifier. An identifier is any number or series of characters assigned to a data element. In a particular embodiment, an identifier is a unique number or series of characters that uniquely and consistently identifies a financial security or similar item. For example, a particular identifier may be associated with a particular holding in an account. In other embodiments, an identifier includes a ticker symbol, a name of a security, or similar information. Similar identifiers are used for data retrieved from multiple financial institutions and multiple financial accounts, thereby allowing the retrieved data to be normalized across the multiple institutions and accounts. When assigning identifiers to data elements, one or more rules may be applied to properly identify the data elements. The particular rules applied to a particular data element may vary depending on the source of the data element.

As used herein, the term “data element” refers to any data associated with a financial security (or other item) from any data source. Example data elements include ticker symbols, security names, number of shares, date purchased, date sold, coupon rate, maturity date, security type, industry classification, and the like. As used herein, the terms “account holder”, “customer”, “user”, and “client” are interchangeable. A data element may also refer to a particular account holding, such as a particular stock or a particular bond. “Account holder” refers to any person having access to an account. Various financial account and financial institution examples are provided herein for purposes of explanation. However, it will be appreciated that the systems and procedures described herein can be used with any type of data from any data source. Example financial accounts include savings accounts, money market accounts, checking accounts (both interest-bearing and non-interest-bearing), brokerage accounts, credit card accounts, mortgage accounts, home equity loan accounts, overdraft protection accounts, margin accounts, personal loan accounts, and the like. Example financial institutions include banks, savings and loans, credit unions, mortgage companies, mutual fund companies, lending companies, and stock brokers.

Additionally, a data aggregation system may aggregate data from multiple sources, such as multiple financial accounts, multiple email accounts, multiple online award (or reward) accounts, multiple news headlines, and the like. Similarly, the data retrieval and data processing systems and methods discussed herein may be applied to collect data from any type of account containing any type of data. Thus, the methods and systems described herein can be applied to a data aggregation system or any other account management system, and are not limited to the financial analysis systems and procedures discussed in the examples provided herein.

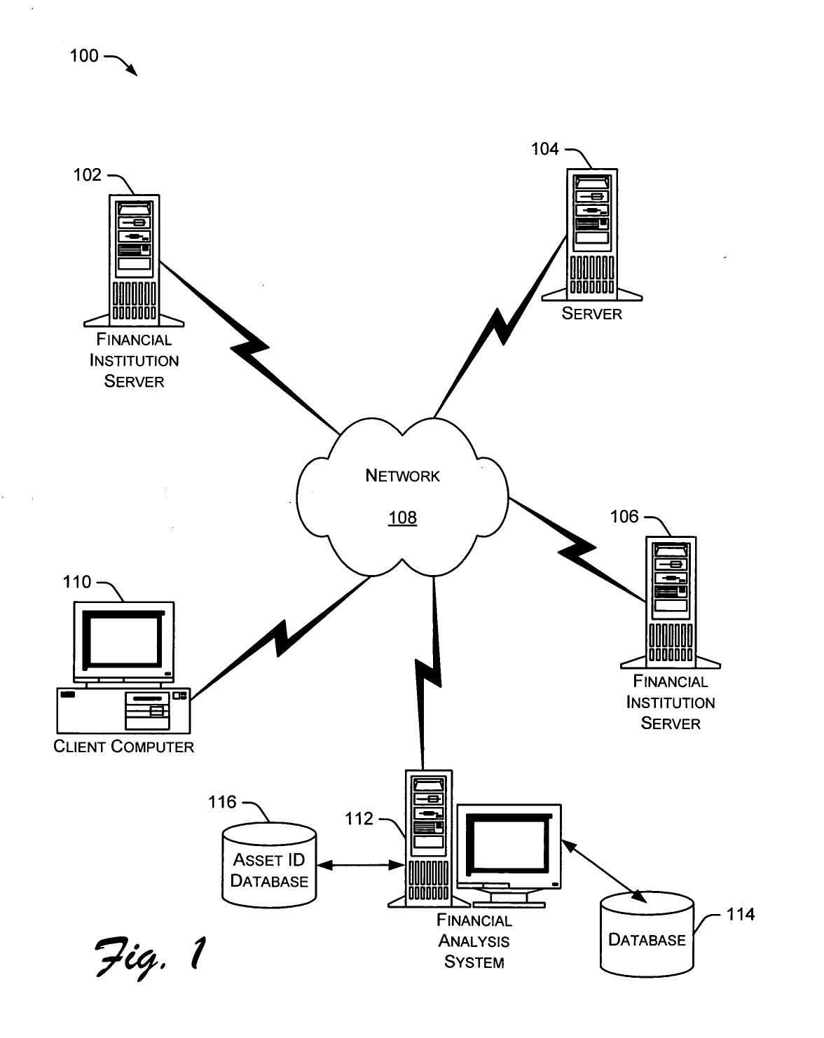

FIG. 1 illustrates an example network environment 100 in which various servers, computing devices, and a financial analysis system exchange data across a network, such as the Internet. The network environment of FIG. 1 includes multiple financial institution servers 102 and 106 coupled to a data communication network 108, such as the Internet. Data communication network 108 may be any type of data communication network using any network topology and any communication protocol. Further, network 108 may include one or more sub-networks (not shown) which are interconnected with one another.

Another server 104, a client computer 110 and a financial analysis system 112 are also coupled to network 108. Financial analysis system 112 is coupled to an asset ID database 116. Asset ID database 116 may also be referred to as an “asset master” or a “security master”. An asset ID is a unique identifier (such as a number or a series of alphanumeric characters) within an identification architecture that is associated with a particular security or a particular class of securities. For example, an asset ID may be associated with a particular stock or a particular bond. An example of an asset ID is a CUSIP (Committee on Uniform Securities Identification Procedures) number. CUSIP is a committee that supplies a unique nine character identification, referred to as a CUSIP number, for each class of security approved for trading in the United States to facilitate clearing and settlement of transactions. Other types of asset IDs include ticker symbols and proprietary identifiers developed by particular financial institutions.

Financial analysis system 112 also includes a database 114 that stores various data collected and generated by the financial analysis system. Database 114 may also store various identifiers (e.g., ticker symbols), transaction information, and the like. Financial analysis system 112 performs various account analysis functions, data analysis functions, and aggregation functions, as discussed in greater detail below. Although not shown in FIG. 1, financial institution servers 102 and 106 may include a database that stores asset identifiers and/or transaction identifiers associated with the particular financial institution.

Servers 102-106, client computer 110, and financial analysis system 112 may be any type of computing device, such as a desktop computer, a laptop computer, a handheld computer, a personal digital assistant (PDA), a cellular phone, a set top box, or a game console. Client computer 110 is capable of communicating with one or more servers 102-106 to access, for example, information about a financial institution and various user accounts that have been established at the financial institution.

The communication links shown between network 108 and the various devices (102, 104, 106, 110, and 112) shown in FIG. 1 can use any type of communication medium and any communication protocol. For example, any of the communication links shown in FIG. 1 may be a wireless link (e.g., a radio frequency (RF) link or a microwave link) or a wired link accessed via a public telephone system or another communication network.

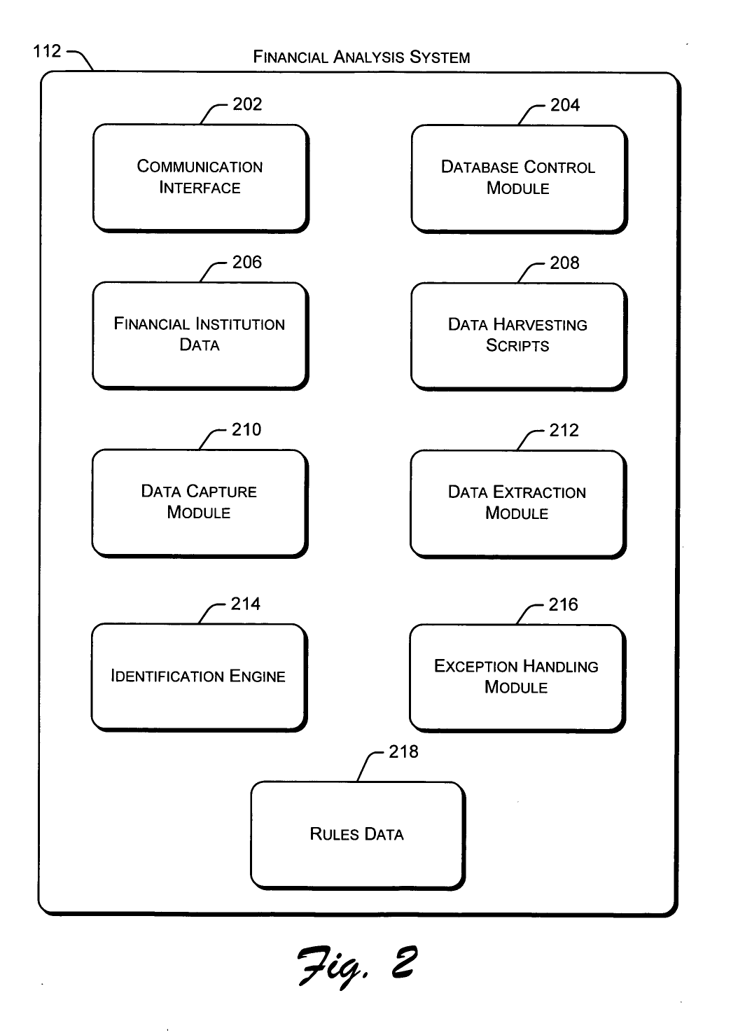

FIG. 2 is a block diagram showing example components and modules of financial analysis system 112. A communication interface 202 allows the financial analysis system 112 to communicate with other devices, such as one or more servers or computing devices. In one embodiment, communication interface 202 is a network interface to a local area network (LAN), which is coupled to another data communication network, such as the Internet.

A database control module 204 allows financial analysis system 112 to store data to database 114 and retrieve data from the database. Financial analysis system 112 also stores various financial institution data 206, which may be used to locate and communicate with various financial institution servers. Financial institution data 206 includes, for example, account balance information, transaction descriptions, transaction amounts, security holdings, asset identifiers and transaction identifiers.

A variety of data harvesting scripts 208 are also maintained by financial analysis system 112. For example, a separate data harvesting script 208 may be maintained for each financial institution or other data source from which data is extracted. Data harvesting (also referred to as “screen scraping”) is a process that allows, for example, an automated script to retrieve data from one or more web pages associated with a web site. Data harvesting may also include retrieving data from a data source using any data acquisition or data retrieval procedure.

Financial analysis system 112 also includes a data capture module 210 and a data extraction module 212. Data capture module 210 captures data (such as web pages or OFX (Open Financial Exchange) data) from one or more data sources. Data extraction module 212 retrieves (or extracts) data from captured web pages or other data sources. Data extraction module 212 may use one or more data harvesting scripts 208 to retrieve data from a web page.

Data capture module 210 may also retrieve data from data sources other than web pages. For example, data capture module 210 can retrieve data from a source that supports the OFX specification or the Quicken Interchange Format (QIF). OFX is a specification for the electronic exchange of financial data between financial institutions, businesses and consumers via the Internet. OFX supports a wide range of financial activities including consumer and business banking, consumer and business bill payment, bill presentment, and investment tracking, including stocks, bonds, mutual funds, and 401(k) account details. QIF is a specially formatted text file that allows a user to transfer Quicken transactions from one Quicken account register into another Quicken account register or to transfer Quicken transactions to or from another application that supports the QIF format.

An identification engine 214 analyzes data and various rules to associate identifiers with data or data elements. For example, identification engine 214 can analyze financial account data retrieved from one or more financial institutions. The retrieved data may be obtained by harvesting information from a web site or other data source. Identification engine 214 identifies data elements contained in the financial account data and associates an asset identifier or a transaction identifier with each data element. If an identifier cannot be determined for a particular data element, an exception handling module 216 allows an administrator, developer, or other user to associate an identifier with the particular data element or modify the logic rules associated with the identification. Similarly, if multiple identifiers are determined for a particular data element, exception handling module 216 allows a user to associate a single identifier with the particular data element or modify the logic rules associated with the identification. Exception handling module 216 may also be referred to as an “exception handling tool”. For example, exception handling module 216 allows the user to add new rules, delete rules, or modify rules such that the particular data element will be processed automatically (i.e., without user intervention) in the future by identification engine 214. By continually adding, deleting and modifying rules, the overall performance of the rules in associating identifiers with data elements improves over time.

Financial analysis system 112 also includes rules data 218. For example, this rules data is used by identification engine 214 to identify asset identifiers associated with one or more data elements. Rules data 218 may include generic rules and/or one or more sets of rules related to particular financial institutions or other organizations.

Although a single identification engine 214 is shown in FIG. 2, alternate embodiments of financial analysis system 112 may include multiple identification engines, such as an asset identification engine, a transaction identification engine, and a proprietary identification engine (e.g., proprietary to a particular financial institution).

In particular embodiments, one or more of the components shown in FIG. 2 may be omitted from financial analysis system 112, or one or more additional components may be added to financial analysis system 112. Additionally, any of the components shown in FIG. 2 may be combined into another component. For example, data capture module 210 and data extraction module 212 may be combined in a single component. The components shown in FIG. 2 can be implemented in hardware, software, or combinations of hardware and software.

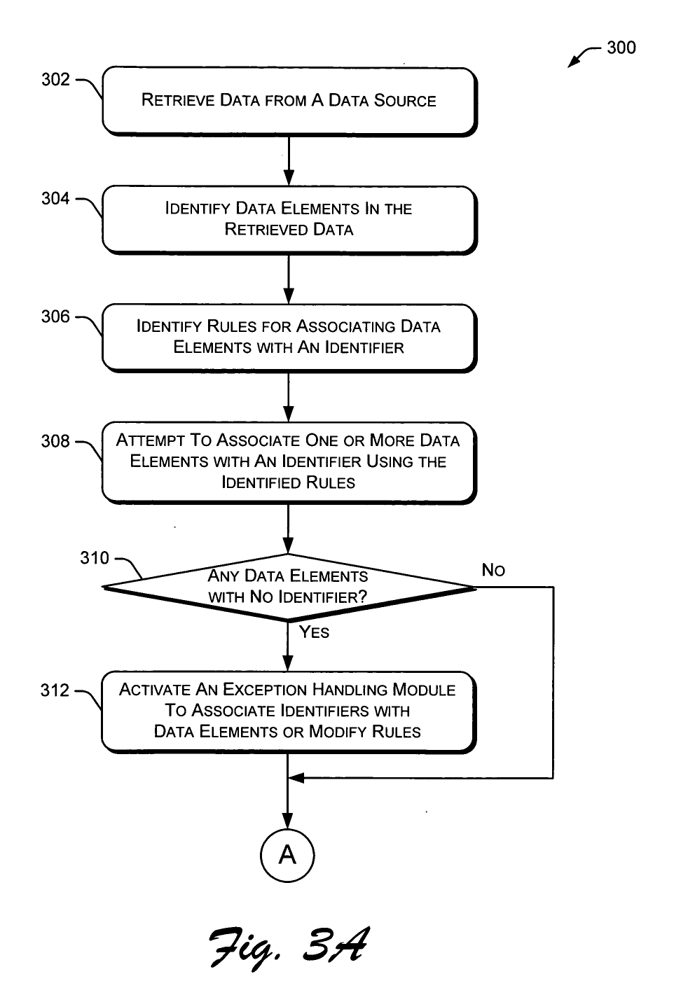

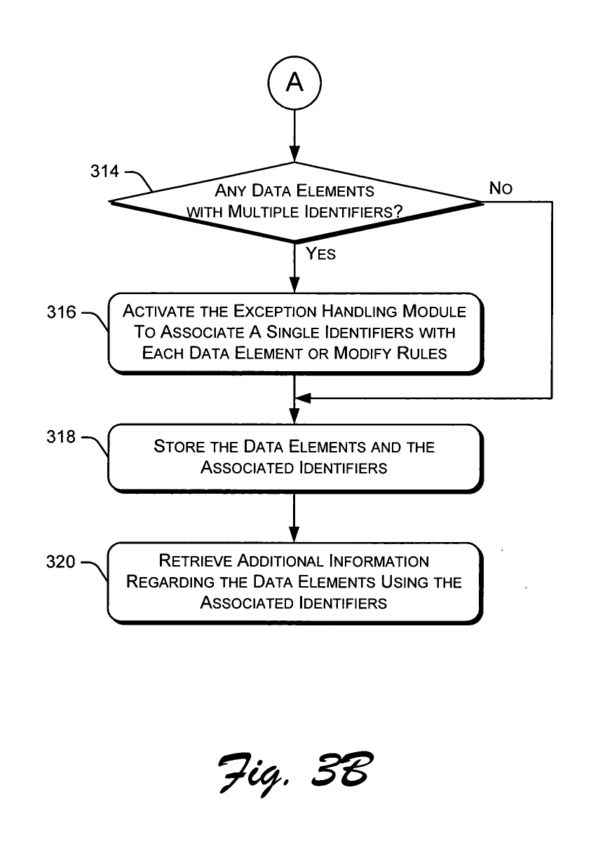

FIGS. 3A and 3B illustrate a flow diagram of a procedure 300 for retrieving data and associating identifiers with the retrieved data. Initially, the procedure retrieves data from a data source, such as a financial institution (block 302). The procedure then identifies various data elements contained in the retrieved data (block 304). These data elements include, for example, one or more account holdings, one or more account transactions, and other data (or portions of data) retrieved from the data source. The procedure then identifies one or more rules for associating data elements with an identifier (block 306). For example, different sets of rules may be used depending on the data source (or data sources) from which the data elements were retrieved. Since different data sources may use different identifiers and other information to identify data elements, different rules may be necessary to properly identify data elements from the different data sources. For example, different ticker symbols or different naming formats may be used by different data sources. Further, rules may be applied in different orders for different data sources to increase the likelihood of properly identifying the data element and/or to reduce the time required to identify the data element. In certain embodiments, the same set of rules may be associated with two or more different data sources. This identification of rules may be performed by identification engine 214 (FIG. 2).

Next, the procedure attempts to associate one or more data elements with an identifier using the rules identified above (block 308). This association may be performed, for example, by identification engine 214 (FIG. 2). As discussed in greater detail below, any number of rules or other information is useful in associating identifiers with data elements. Identifiers include asset identifiers, transaction identifiers, and the like.

Procedure 300 continues by determining whether any data elements do not have an associated identifier after processing the retrieved data (block 310). If so, an exception handling module (e.g., module 216 in FIG. 2) is activated to associate identifiers with data elements that do not have associated identifiers (block 312). Additionally, one or more rules may be added or existing rules may be modified to increase the likelihood of successfully associating an identifier with the data elements in the future. Next, the procedure determines whether any data elements have multiple associated identifiers (block 314). This situation occurs when the applied rules indicate two or more possible identifiers that may be associated with a data element. If this occurs, the exception handling module is activated to associate a single identifier with each of the data elements having multiple associated identifiers (block 316). Additionally, one or more rules may be added or existing rules may be modified to increase the likelihood of successfully associating a single identifier with the data elements in the future.

After ensuring that one or more data elements have associated identifiers, procedure 300 stores the data elements and the identifiers associated with the data element (block 318). The procedure continues by optionally retrieving additional information regarding the data elements using the associated identifiers (block 320). For example, a group of data elements may be associated with a particular asset identifier (also referred to as an “asset code” or an “asset ID”). Additional information regarding this asset may be retrieved from a database or another data source. For example, the procedure may access an asset ID database to obtain more information regarding the particular asset ID. This additional information includes, for example, pricing feeds, industry codes, security size, security type, and the like. This additional information may be obtained from any number of different data sources. In a particular embodiment, an identifier is associated with a single data element. In other embodiments, identifiers are associated with multiple data elements, such as a group or set of data elements.

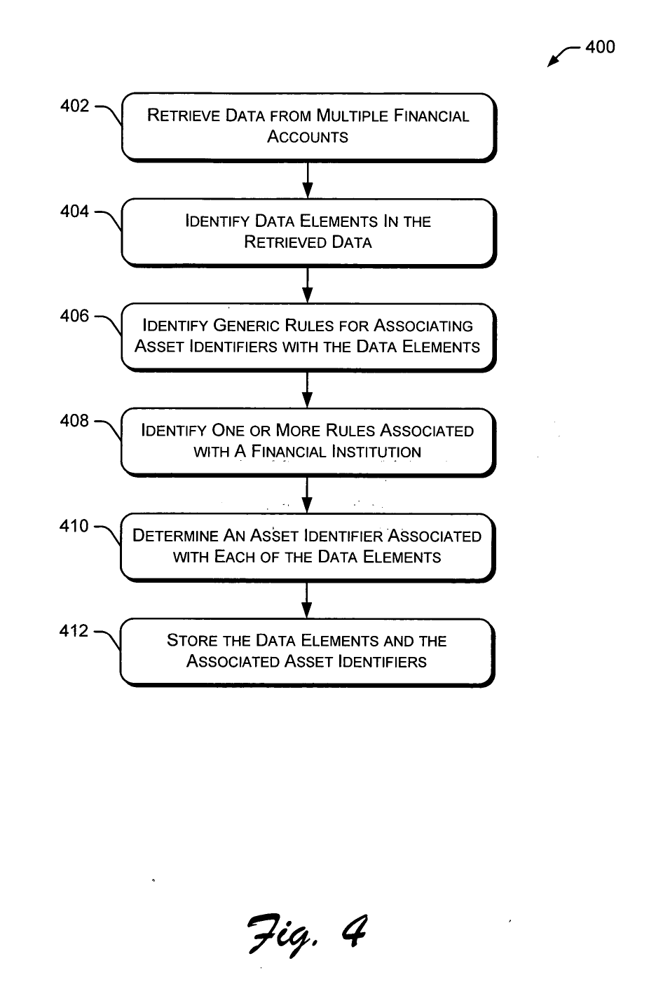

FIG. 4 is a flow diagram illustrating a procedure 400 for retrieving data from multiple financial accounts and associating asset identifiers with the retrieved data based on various rules. Initially, data is retrieved from multiple financial accounts (block 402). The procedure then identifies data elements in the retrieved data (block 404). Procedure 400 continues by identifying generic rules for associating asset identifiers with the data elements (block 406). These rules may be related to a group of financial institutions, or a particular industry or organization.

Procedure 400 then identifies rules associated with a particular financial institution (block 408). Alternatively, the rules may be associated with a group of financial institutions or another organization. The procedure determines an asset identifier associated with each of the data elements by applying the rules (generic and/or associated with a particular financial institution) to the data elements (block 410). The data elements and the associated asset identifiers are then stored for future use (block 412). Although the embodiment of FIG. 4 refers to asset identifiers, similar procedures may be used in alternate embodiments to identify transaction identifiers and other types of information. In these alternate embodiments, the same rules may be used to determine other identifiers or different sets of rules may be identified to associate other identifiers with the data elements.

As mentioned above, data is retrieved from one or more data sources, such as financial institutions. In one embodiment, data is retrieved by capturing an HTML (HyperText Markup Language) screen from a financial institution web site. For example, the HTML screen may be a web page associated with the financial institution. Data is then extracted from the HTML screen using a data harvesting script. The extracted data can be normalized, which refers to the process of arranging the extracted data into a standard format. The normalized data is then stored in a database (e.g., database 114 in FIG. 1) for future reference.

The normalizing of data is useful when collecting data from multiple sources (e.g., multiple financial institutions). Each financial institution may use different identifiers or other terms for the same type of data. For example, one financial institution may use the identifier “ACME.A” while another financial institution uses the identifier “ACME.C.A” for the same security. By normalizing the data elements, data elements can be grouped in a logical manner. Thus, various financial analysis tools and procedures can analyze data across multiple financial institutions or other data sources. For example, all identifiers related to a particular identifier are normalized to that common identifier. For example, if the identifier is “ACME.A”, the related identifier “ACME.C.A” is normalized to the “ACME.A” identifier. This normalization enhances the handling of data from multiple data sources by relating different identifiers associated with the same security to a common identifier.

Normalization can be performed by converting an identifier from one format to another (e.g., converting “ACME.C.A” to “ACME.A”). Alternatively, one or more rules may associate different holdings or ticker symbols with the same asset identifier. For example, a first rule may associate “ACME.C.A” with asset identifier “12345”. Similarly, a second rule may associate “ACME.A” with the same asset identifier “12345”.

As mentioned above, data harvesting (or screen scraping) is a process that allows a script to retrieve data from a web site and store the retrieved data in a database. Data harvesting scripts are capable of navigating web sites and capturing individual HTML pages. For example, JavaScript and images may be removed from the HTML pages or converted into HTML text if it contains account information. A parser then converts the HTML data into a field-delimited XML format. The XML data communicates with enterprise java beans (EJBs) through an XML converter. EJBs perform a series of SQL queries that populate the data into the database.

When retrieving data from a data source other than an HTML screen, the data source may communicate data using the OFX standard, the QIF format, or any other data format. Data is retrieved from the source and a procedure identifies data of interest. The data of interest may be, for example, data associated with a particular financial institution. The identified data is then normalized and stored in a database. The database may contain data related to other customers and/or data collected from other sources (such as HTML screens).

One or more sets of rules (also referred to as “search patterns”) may be applied when determining identifiers associated with a data element. Different sets of rules may be associated with different financial institutions or with different types of data elements. In a particular embodiment, a first set of rules includes generic rules that may be applied to different types of data elements associated with different financial institutions. In this embodiment, other sets of rules are specific to a particular financial institution or to a particular type of data element. In other embodiments, any number of rules (or sets of rules) may be used when determining identifiers associated with data elements.

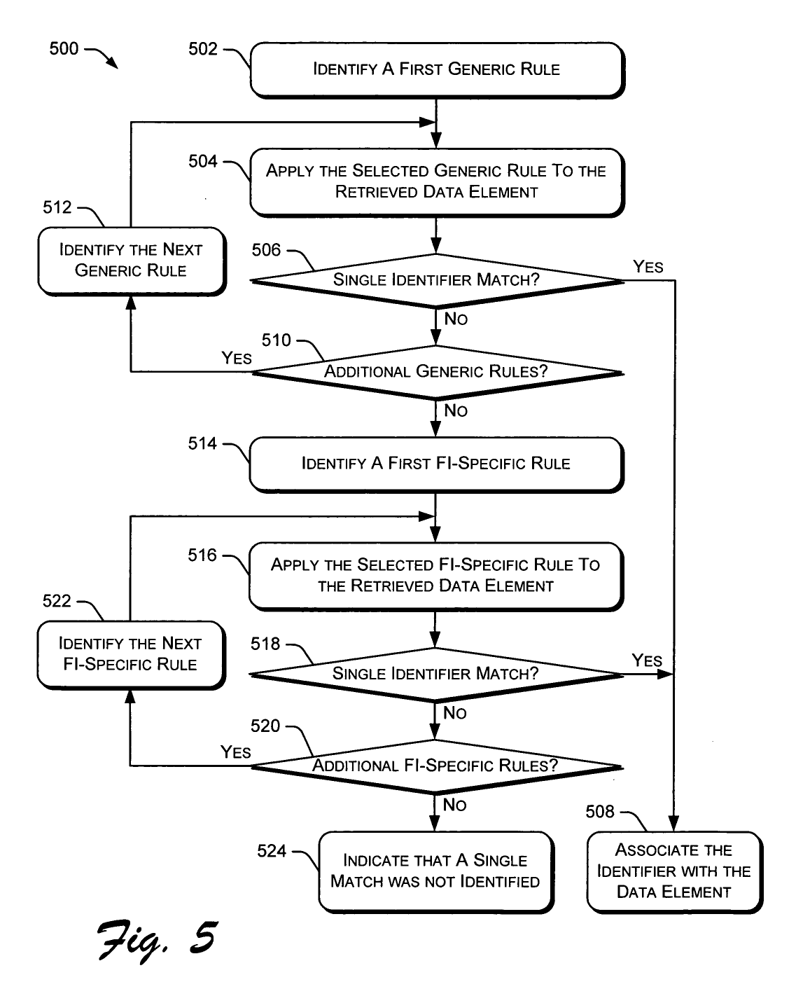

FIG. 5 is a flow diagram illustrating a procedure 500 for applying various rules or search patterns to determine an identifier associated with a data element. Initially, procedure 500 identifies a first generic rule (block 502) from a set of one or more generic rules. The procedure applies the selected generic rule to the retrieved data element (block 504). Next, the procedure determines whether application of the selected generic rule has resulted in a single identifier being matched with (or associated with) the retrieved data element (block 506). If so, the identifier is associated with the data element and the procedure is complete for that particular data element (block 508).

If a single identifier match has not occurred in block 506, the procedure determines whether there are additional generic rules to apply (block 510). If so, the procedure identifies the next generic rule (block 512) and returns to block 504 to apply the next generic rule to the received data element. If all generic rules have been applied, the procedure continues from block 510 to block 514, which identifies a first financial institution-specific (FI-specific) rule. FI-specific rules are associated with a particular financial institution and incorporate information specific to the financial institution, such as security naming conventions, ticker symbol formats, and the like. For example, a particular FI-specific rule may change the abbreviation “FD” to “FUND” to provide a consistent naming convention among multiple data sources.

Procedure 500 continues by applying the selected FI-specific rule to the retrieved data element (block 516). The procedure then determines whether application of the selected FI-specific rule has resulted in a single identifier being matched with (or associated with) the retrieved data element (block 518). If so, the identifier is associated with the data element and the procedure is complete for that particular data element (block 508).

If a single identifier match has not occurred in block 518, the procedure determines whether there are additional FI-specific rules to apply (block 520). If so, the procedure identifies the next FI-specific rule (block 512) and returns to block 516 to apply the next FI-specific rule to the received data element. If all FI-specific rules have been applied, the procedure continues from block 520 to block 524, which generates an indication that a single match was not identified by applying the various generic and FI-specific rules. Although the example of FIG. 5 applies generic rules before FI-specific rules, alternate embodiments may apply rules in any order. For example, one or more FI-specific rules may be applied before applying one or more generic rules. In other embodiments, one or more FI-specific rules are applied instead of any generic rules.

In a particular implementation, application of each rule may narrow a pool of possible identifiers that may be associated with a particular data element. For example, application of a first rule may narrow a pool of possibilities to ten possible identifiers. The second rule is then applied to these ten possible identifiers, which narrows the pool to three possible identifiers. The third rule is applied to those three possible identifiers, but may not further reduce the size of the pool. Finally, a fourth rule is applied to the three possible identifiers and results in a single identifier that is associated with the data element. In other examples, any number of rules may be applied before a single identifier is determined.

In another implementation, each rule is applied to the entire universe of possible identifiers. Thus, if the first rule does not identify a single identifier, the next rule is applied. Each subsequent rule is more specific or combines one or more selection features of the previous rules. These rules may be prioritized to efficiently and accurately identify the proper identifier for one or more data elements.

In some situations, application of all rules leaves a pool of two or more possible identifiers. In this situation, a user may manually determine which identifier is the correct identifier for the data element. Additionally, a new rule may be developed or an existing rule may be modified to handle this situation in the future.

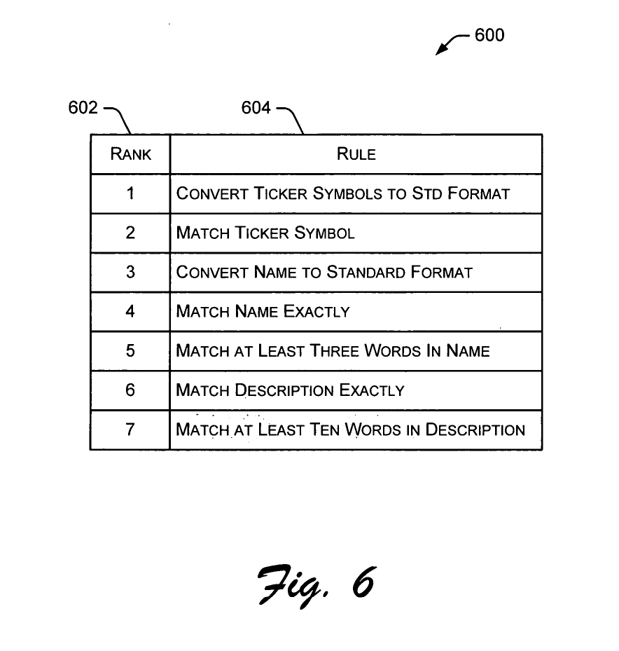

FIG. 6 illustrates an example set of rules 600 used to associate data elements with identifiers. A first column 602 identifies a ranking or priority associated with each rule identified in a second column 604. In the example of FIG. 6, a first rule converts ticker symbols to a standard format. For example, if a particular financial institution represents ticker symbols in a particular format, the format of ticker symbols associated with that financial institution is converted into a standard format used for all ticker symbols from any data source. Thus, if the data element contains a non-standard ticker symbol, that ticker symbol is converted to a standard format. The next rule attempts to match the data element with a particular ticker symbol from a list of all possible ticker symbols. If a single match is not identified, the next rule converts non-standard names in the data element to a standard format. The next rule attempts to match the data element with a name from a list of possible security names. If an exact match is not identified, the next rule determines whether a match of at least three words in the name is found. If not, the next rule attempts to match the exact description with a description from a list of possible security descriptions. If there is still no match, the last rule shown attempts to match at least ten words in the description.

In alternate embodiments, a set of rules may include any number of rules. Further, multiple sets of rules may be applied to a particular data element when attempting to associate the data element with an identifier. Further, the order in which rules are applied may vary. For example, in FIG. 6, the second rule (match ticker symbol) may be applied first. If that rule does not identify a single identifier, then the first rule (convert ticker symbols to standard format) is applied to the data element. Any number of rules may be applied in any order when attempting to identify an identifier associated with a data element.

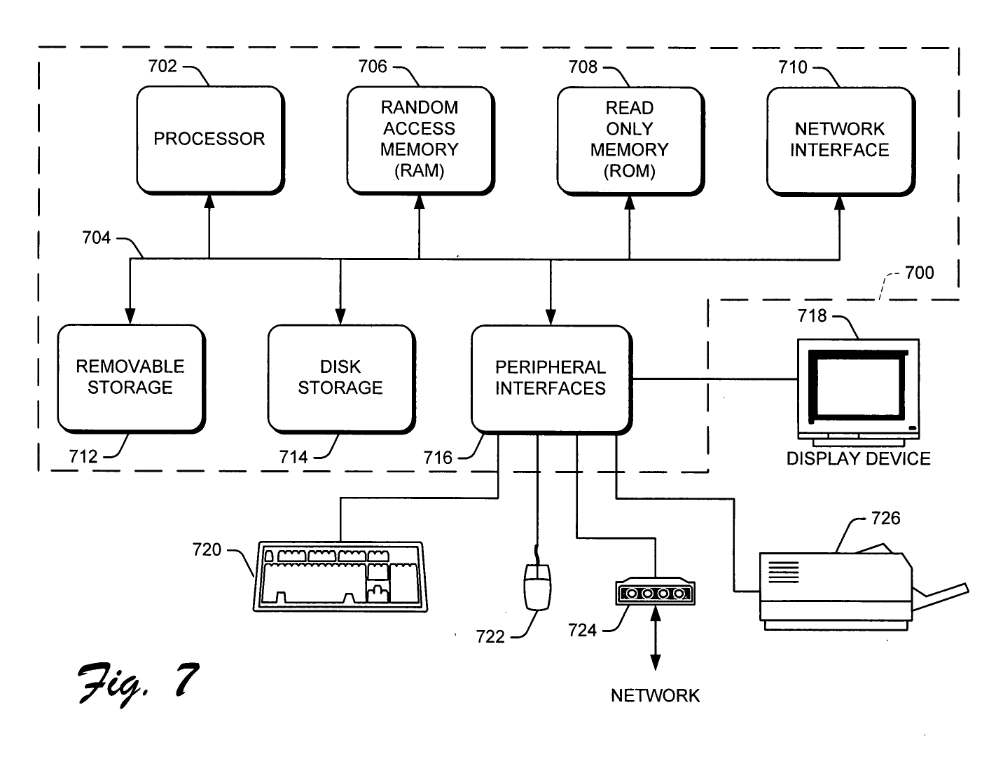

FIG. 7 is a block diagram showing pertinent components of a computer 700 in accordance with the invention. A computer such as that shown in FIG. 7 can be used, for example, to perform various procedures such as those discussed herein. Computer 700 can also be used to access a data source or other device to access various financial information. The computer shown in FIG. 7 can function as a server, a client computer, or a financial analysis system, of the types discussed herein.

Computer 700 includes at least one processor 702 coupled to a bus 704 that couples together various system components. Bus 704 represents one or more of any of several types of bus structures, such as a memory bus or memory controller, a peripheral bus, and a processor or local bus using any of a variety of bus architectures. A random access memory (RAM) 706 and a read only memory (ROM) 708 are coupled to bus 704. Additionally, a network interface 710 and a removable storage device 712, such as a floppy disk or a CD-ROM, are coupled to bus 704. Network interface 710 provides an interface to a data communication network such as a local area network (LAN) or a wide area network (WAN) for exchanging data with other computers and devices. A disk storage 714, such as a hard disk, is coupled to bus 704 and provides for the non-volatile storage of data (e.g., computer-readable instructions, data structures, program modules and other data used by computer 700). Although computer 700 illustrates a removable storage 712 and a disk storage 714, it will be appreciated that other types of computer-readable media which can store data that is accessible by a computer, such as magnetic cassettes, flash memory cards, digital video disks, and the like, may also be used in the example computer.

Various peripheral interfaces 716 are coupled to bus 704 and provide an interface between the computer 700 and the individual peripheral devices. Example peripheral devices include a display device 718, a keyboard 720, a mouse 722, a modem 724, and a printer 726. Modem 724 can be used to access other computer systems and devices directly or by connecting to a data communication network such as the Internet.

A variety of program modules can be stored on the disk storage 714, removable storage 712, RAM 706, or ROM 708, including an operating system, one or more application programs, and other program modules and program data. A user can enter commands and other information into computer 700 using the keyboard 720, mouse 722, or other input devices (not shown). Other input devices may include a microphone, joystick, game pad, scanner, satellite dish, or the like.

Computer 700 may operate in a network environment using logical connections to other remote computers. The remote computers may be personal computers, servers, routers, or peer devices. In a networked environment, some or all of the program modules executed by computer 700 may be retrieved from another computing device coupled to the network.

Typically, the computer 700 is programmed using instructions stored at different times in the various computer-readable media of the computer. Programs and operating systems are often distributed, for example, on floppy disks or CD-ROMs. The programs are installed from the distribution media into a storage device within the computer 700. When a program is executed, the program is at least partially loaded into the computer's primary electronic memory. As described herein, the invention includes these and other types of computer-readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

Although the description above uses language that is specific to structural features and/or methodological acts, it is to be understood that the invention defined in the appended claims is not limited to the specific features or acts described. Rather, the specific features and acts are disclosed as example forms of implementing the invention.

1. A method comprising:
retrieving financial data from a data source, wherein the financial data includes a plurality of financial data elements;
identifying a plurality of rules associated with the financial data elements;
applying the plurality of rules associated with the financial data elements to the financial data elements;
associating each of the plurality of financial data elements with an identifier; and
identifying additional information regarding each financial data element using the identifier associated with the financial data element.

2. A method as recited in claim 1 further comprising storing each of the plurality of financial data elements and the identifier associated with each financial data element.

3. A method as recited in claim 1 wherein the data source is a web site.

4. A method as recited in claim 1 wherein the financial data elements represent positions in a financial account.

5. A method as recited in claim 1 wherein the identifier is an asset identifier.

6. A method as recited in claim 1 wherein the identifier is associated with a particular financial institution.

7. A method as recited in claim 1 further comprising converting data elements representing ticker symbols to a standard ticker symbol format.

8. A method as recited in claim 1 further comprising converting data elements representing security names to a standard security name format.

9. A method as recited in claim 1 wherein applying the plurality of rules includes matching data elements to a standard security name format.

10. A method as recited in claim 1 further comprising associating an exception identifier with each financial data element for which an associated identifier is not identified.

11. A method as recited in claim 10 further comprising manually associating identifiers with financial data elements having an associated exception identifier.

12. A method as recited in claim 10 further comprising generating a new rule to associate identifiers with financial data elements having an associated exception identifier.

13. A method as recited in claim 1 wherein applying the plurality of rules includes applying the plurality of rules in a particular order.

14. A method as recited in claim 1 further comprising retrieving the additional information regarding the financial data elements from a financial database.

15. A method as recited in claim 1 further comprising retrieving additional information associated with the financial data elements from an asset ID database.

16. A method as recited in claim 1 further comprising normalizing the plurality of financial data elements.

17. One or more computer-readable memories containing a computer program that is executable by a processor to perform the method recited in claim 1.

18. A method comprising:
accessing a web page associated with a financial institution;
retrieving data from the web page using a data harvesting script;
identifying financial data contained in the data retrieved from the web page, wherein the financial data includes a plurality of financial data elements;
applying rules associated with the financial institution to associate each of the plurality of financial data elements with an asset identifier; and
sorting the plurality of financial data elements based on the associated asset identifier.

19. A method as recited in claim 18 further comprising storing each of the plurality of financial data elements and the asset identifier associated with the financial data element.

20. A method as recited in claim 18 further comprising converting each of the plurality of financial data elements from a first format to a second format.

21. One or more computer-readable memories containing a computer program that is executable by a processor to perform the method recited in claim 18.

22. A method comprising:
retrieving financial data from a plurality of financial accounts;
identifying data elements contained in the retrieved financial data;
identifying rules for associating asset identifiers with the data elements, wherein the rules are associated with a particular financial institution; and
applying the rules to associate an asset identifier with each of the data elements.

23. A method as recited in claim 22 further comprising:
determining whether at least one data element has multiple associated asset identifiers after applying the rules; and
modifying the rules to associate a single asset identifier with at least one data element.

24. A method as recited in claim 22 further comprising:
determining whether at least one data element does not have an associated asset identifier after applying the rules; and
modifying the rules to associate an asset identifier with at least one data element.

25. One or more computer-readable memories containing a computer program that is executable by a processor to perform the method recited in claim 22.
